(19) United States
(12) Patent Application Publication
(10) Pub. No.: US 2012/0050833 A1
(43) Pub. Date: Mar. 1, 2012

(54) Methods and Apparatus for Holographic Animation

(75) Inventors: Victor Michael Bove, JR., Wrentham, MA (US); Daniel Smalley, Cambridge, MA (US); Quinn Smithwick, Glendale, CA (US)

(73) Assignee: MASSACHUSETTS INSTITUTE OF TECHNOLOGY, Cambridge, MA (US)

(21) Appl. No.: 12/871,041

(22) Filed: Aug. 30, 2010

(51) Int. Cl. G03H 1/30

(52) U.S. Cl. 359/26; 359/25

(57) ABSTRACT

In an illustrative implementation of this invention, an animated holographic display is created as follows: Multiple HPO holograms in the shape of horizontal strips are recorded on an H2 medium. These horizontal strips are vertically displaced from each other. An animated real image is displayed by sequentially illuminating these HPO holograms.

Unless corrected, this approach causes the animated image to appear to rotate vertically. The vertical parallax rotation arises because, when recording the HPO holograms, the vertical perspectives of the various HPO holograms differ.

In illustrative implementations of this invention, this vertical parallax rotation may be corrected at least three different ways: (1) the content of H1 may be pre-rotated, (2) H1, H2 or both may be translated during exposures, or (3) only a thin horizontal stripe of H1 may be illuminated during holographic transfer to eliminate vertical parallax in the real image transmitted from H1.

### FIELD OF THE TECHNOLOGY

The present invention relates generally to holograms.

### SUMMARY OF THE INVENTION

First, a few definitions:

“H1” refers to a master hologram.

“H2” refers to a transfer hologram.

“HPO” means horizontal parallax only.

As used herein, “HPO stripe hologram” or “HPO stripe” means an HPO hologram recorded on a thin strip of a holographic plate or other holographic medium.

In an illustrative implementation of this invention, an animated holographic display is created as follows: multiple HPO stripes are recorded on an H2. These HPO stripes are aligned horizontally, and are vertically displaced from each other (analogous to how horizontal stripes on a flag are vertically displaced from each other). An animated real image is displayed by sequentially illuminating these HPO stripes.

In this illustrative implementation, the H2 plate is created by succession of HPO hologram transfers from H1 master holograms to an H2 transfer plate covered with a photosensitive emulsion. During the exposure of the first HPO stripe, an H1 is illuminated but only a horizontal stripe of the H2 transfer plate is exposed. On the next exposure an H1 is illuminated and the horizontal stripe above or below the first stripe is exposed on the H2. Each of the resulting HPO stripe holograms on the H2 may be thought of as a “frame” of the animation. By sequentially illuminating these “frames”, an animated holographic display is created.

This approach would have the following problem (unless it were corrected): to a viewer watching the animated holographic display, objects would appear to rotate vertically. The vertical parallax rotation would arise because, when the HPO stripes are recorded, the vertical perspective seen from one HPO stripe is different from the vertical perspective seen from another, since the stripes are vertically displaced from each other.

In illustrative implementations of this invention, this problem of object rotation may be solved—i.e., the vertical perspective may be made consistent from one exposure to the next—in at least three different ways. First, the content of H1 may be pre-rotated. Second, H1 or H2 or both may be translated between exposures. These first two approaches allow the entire H1 to be illuminated during holographic transfer to the H2.

In contrast, the third solution involves illuminating a narrow horizontal stripe of H1 during holographic transfer. For example, the third solution may be implemented as follows: When exposing the HPO stripes on the H2, the entire H1 is not illuminated. Instead, only a horizontal stripe of the H1 is illuminated. A vertical diffuser is inserted between the H1 and H2. The stripe illumination of H1 allows only one vertical perspective to propagate and a diffuser allows that perspective to be seen from every vertical position on the H2.

### BRIEF DESCRIPTION OF THE DRAWINGS

FIGS. 1 through 13 show illustrative implementations of this invention.

FIG. 1 is a diagram of an off-axis transmission hologram being captured by an H1 plate.

FIG. 2 is a diagram that shows holographic transfer from of a full aperture H1 plate to slit aperture H2 plate.

FIG. 3 is a diagram of a HPO hologram on an H2 plate being illuminated from behind in such a way as to display a real image to a viewer.

FIG. 4 is a diagram of a different HPO hologram on an H2 plate being illuminated from behind. By sequentially illuminating different HPO holograms on an H2 plate, different real images are rapidly displayed in sequence. To a viewer, it appears that the real image is animated.

FIG. 5 is a diagram of a source of monochromatic light, being moved to sequentially illuminate different HPO stripes.

FIG. 6 is a diagram of an array of sources of monochromatic light, that may be turned on and off to illuminate different HPO stripes.

FIG. 7 is a diagram that shows holographic transfer from H1 to H2, in which only a narrow stripe of H1 is illuminated.

FIG. 8 is a diagram that shows ways to correct vertical parallax rotation.

FIG. 9 is a diagram that shows multiple HPO stripes being illuminated at the same time to provide some vertical parallax.

FIG. 10 is a diagram of HPO stripes embossed on a foil H2 that runs on rollers.

FIG. 11 is a diagram that shows ways to control when slides change in a holographic slide show.

FIG. 12 is a diagram that shows multiple HPO stripes being illuminated to display multiple, independent real images.

FIG. 13 is a diagram that shows the use of a shutter.

### DESCRIPTION OF THE INVENTION

In an illustrative implementation of this invention, an animated holographic image is created by sequentially illuminating different HPO stripes on an H2 plate. Each HPO stripe on H2 is created by holographic transfer from an H1 master hologram.

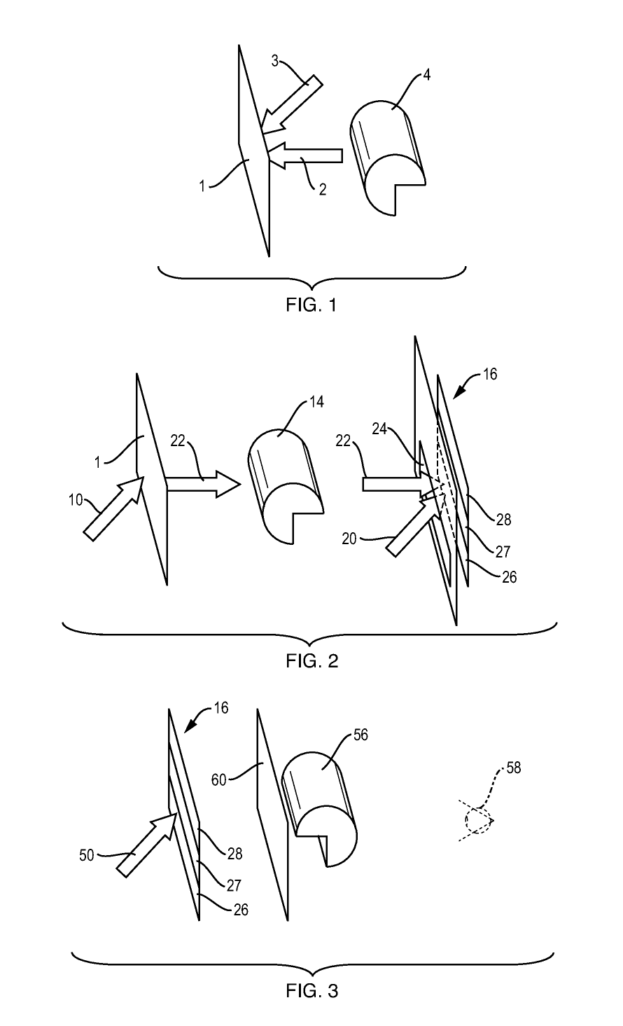

FIG. 1 is a diagram that shows the capture of an off-axis transmission hologram by an H1 plate, in an illustrative implementation of this invention. An H1 plate 1 is illuminated by an object beam 2 and a reference beam 3. The object beam 2 comprises diffusely reflected light from an object 4. The reference beam 3 is a uniform intensity beam. The reference beam and object beam overlap to form a holographic interference pattern that is recorded on the H1 plate.

FIG. 2 is a diagram that shows holographic transfer from a full aperture H1 plate to a slit aperture H2 plate, in an embodiment of this invention. An illumination beam 10 illuminates an H1 plate 1 from behind at such an angle as to create a pseudoscopic real image 14 of the object 4. This real image 14 is a conjugate (or approximate conjugate) of the image of the object transmitted by the object beam 2.

In FIG. 2, the real image 14 is shown between H1 and H2. However, this invention may be implemented so that the real image 14 is in front of, straddling, or behind the H2 plate 16. In many cases, it is advantageous for the real image to straddle H2.

In the example shown in FIG. 2, the H2 plate is illuminated by a reference beam 20. The H2 plate is also illuminated by a beam 22 that exits the H1 plate and creates the real image 14. Beams 20 and 22 overlap, and the resulting holographic interference pattern is recorded on the H2 plate. However, beams 20 and 22 pass through a narrow horizontal slit 24 before illuminating H2, so that only a narrow horizontal strip of the H2 plate is exposed. This creates an HPO stripe hologram 26 (i.e., an HPO stripe) on the H2 plate.

In a working prototype of this invention, this slit 24 is 250 mm wide. However, the width of this slit may vary.

Note that, in the example shown in FIG. 2, the slit is between H1 and H2, and results in only a thin horizontal strip of H2 being exposed to create an HPO stripe. This differs from a conventional method of recording a “Benton” or “rainbow” hologram, in which the slit is located behind the H1 plate (rather than between the H1 and H2 plates), and the entire H2 is exposed to create an HPO hologram.

In exemplary embodiments of this invention, one or more sources of monochromatic light provide illumination, including for all object, reference and illumination beams. For example, in a working prototype of this invention, a red 632 nm HeNe laser is used to record (i.e., is used for object beam and reference beam) and a 532 nm green solid state laser is used to illuminate (i.e., is used for an illumination beam). The recording and illumination steps may be entirely independent. For example, the recording step may use one laser, three lasers (color) or no lasers (e.g., optical direct written, imprinted or etched hologram). Also, for example, the illumination step may employ one or more lasers of one or more wavelengths or suitably monochromatic LED or mercury lamp sources with monochromators subject to the limitations of chromatic blur.

A vertically multiplexed H2 plate may be created by a succession of HPO hologram transfers from one or more H1 holograms to the H2 plate. FIG. 2 shows an example of such a vertically multiplexed H2 plate. Each horizontal stripe in FIG. 2 represents a different HPO stripe hologram that is recorded on the H2 plate 16. These HPO stripes are displaced vertically from each other, as shown in FIG. 2. FIG. 2 shows only three different stripes 26, 27 and 28, representing three different HPO stripe holograms. In practice, however, the number of HPO stripes recorded on a single H2 may be far greater. For example, in a working prototype of this invention, approximately 40 HPO stripes may be recorded on a single H2 plate.

Each of the HPO stripes recorded on the H2 may be thought of as a “frame” of the animation. To create the appearance of movement, at least some of these “frames” differ from each other. That is, the content of at least some of the HPO stripes differs from the content of at least some others. To achieve this, different master H1 holograms may be used for different HPO hologram transfers. Or, a single H1 master hologram (of a single scene, that is not itself multiplexed) may be used for multiple HPO transfers, by re-illuminating the H1 from a different location or with a different wavelength to rotate, tilt shrink, or stretch an image of an object.

FIG. 3 is a diagram of a HPO stripe being illuminated to display a real image to a viewer, in an illustrative implementation of this invention. An illumination beam 50 illuminates an HPO stripe hologram 26 on an H2 plate 16 at such an angle as to create a real image 56 that can be seen by a human viewer 58. This real image 56 is an orthoscopic image of object 4 (since it is a pseudoscopic image of real image 14, which in turn is a pseudoscopic image of object 4). A vertical diffuser 60 is placed at, or near, the plane of the real image 56. The vertical diffuser 60 expands the vertical height of the view zone.

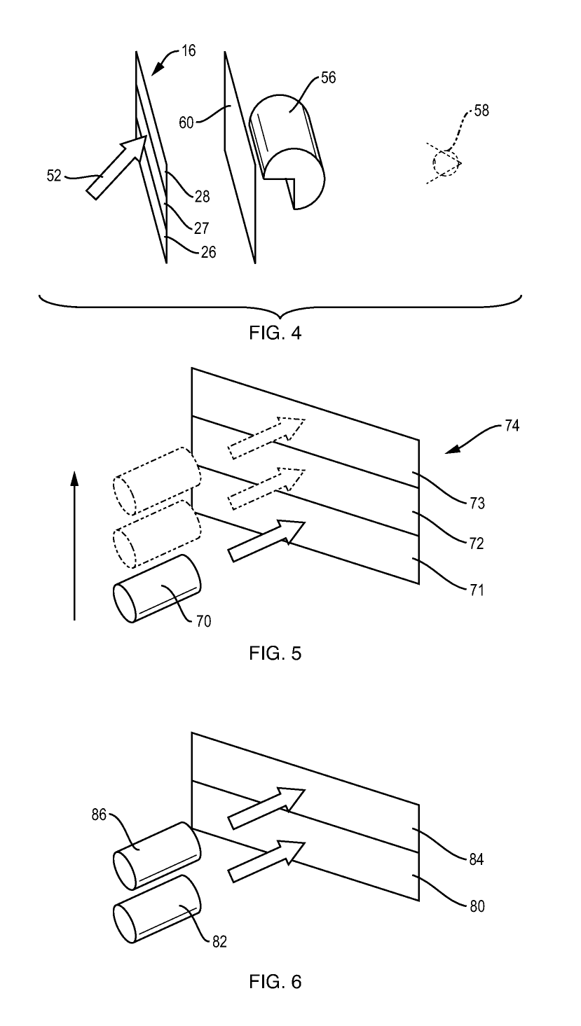

FIG. 4 is a diagram of a different HPO stripe hologram 27 on the same H2 plate 16 being illuminated to create a different real image 60. This different HPO stripe is adjacent to the HPO stripe that was illuminated in FIG. 4.

According to principles of this invention, an animated hologram display may be created by sequentially illuminating different HPO stripes that are vertically multiplexed on an H2 plate. For example, first one HPO stripe may be illuminated, then the HPO stripe above or below it.

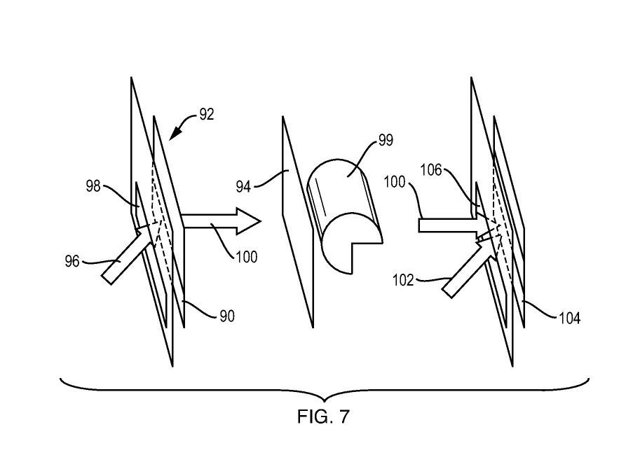

The sequential illumination may be achieved by translating a point source of monochromatic light. For example, as shown in FIG. 5, a point source of light 70 may be translated to illuminate different HPO stripe holograms 71, 72, 73 on an H2 plate. Alternately, a moving light source may be emulated by turning on and off light sources arranged in a row. For example, as shown in FIG. 6, an HPO stripe 80 on an H2 plate may be illuminated by turning on a monochromatic point light source 82, then a different HPO stripe 84 on the H2 plate may be illuminated by a different monochromatic light source 86.

In a working prototype of this invention, an array of lasers is employed. By turning on and off different lasers in this array, a moving light source is emulated.

This approach of sequentially illuminating HPO stripes on a H2 plate would have the following problem (unless it were corrected): to a viewer watching the animated hologram, objects would appear to rotate vertically. The vertical parallax rotation would arise because the vertical perspective seen from one HPO stripe is different from the vertical perspective view seen another, since the stripes are vertically displaced from each other.

In illustrative implementations of this invention, this problem of object rotation may be solved—i.e., the vertical perspective may be made consistent from one exposure to the next—in at least three different ways. First, the content of H1 may be pre-rotated. Second, H1 or H2 or both may be translated between exposures. These first two approaches allow the entire H1 to be illuminated during holographic transfer to the H2. These first two approaches may be used, for example, with the setup shown in FIG. 2.

In contrast, the third solution involves illuminating only a thin stripe of H1 during holographic transfer. An example of this third solution is illustrated in FIG. 7. When exposing the HPO stripes on the H2, the entire H1 is not illuminated. Instead, only a horizontal stripe 90 of the H1 plate 92 is illuminated. The stripe illumination of H1 allows only one vertical perspective to propagate and a diffuser 94 allows that perspective to be seen from every vertical position on the H2. Advantageously, the addition of vertical diffuser 94 may improve the uniformity of the exposures and the total diffraction efficiency of the transfer holograms.

In the example shown in FIG. 7, the stripe illumination is achieved by passing the illumination beam 96 through a slit 98 that is so positioned as to produce the desired vertical perspective. The light that exits the horizontal stripe of the H1 forms a real image 99 that has no vertical parallax. In a working prototype of this invention, this slit 98 is 250 mm wide. However, the width of this slit may vary.

In the example shown in FIG. 7, the H2 plate is illuminated by a reference beam 102. The H2 plate is also illuminated by a beam 100 that exits the H1 plate and creates real image 99. Beams 100 and 102 overlap, and the resulting holographic interference pattern is recorded on the H2 plate. However, beams 100 and 102 pass through a narrow horizontal slit 106 before illuminating H2, so that only a narrow horizontal strip of the H2 plate is exposed. This creates an HPO stripe hologram 104 on the H2 plate.

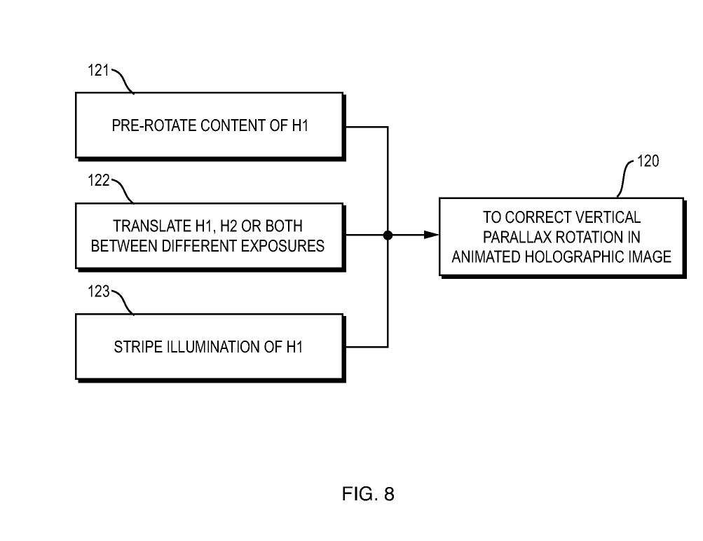

As shown in FIG. 8, the problem of vertical parallax rotation in an animated holographic image may be corrected 120 in at least these three ways: (a) the content recorded on H-1 may be pre-rotated 121, (b) H1, H2 or both may be translated between exposures of H2 122, and (c) only a narrow horizontal stripe of H1 may be illuminated when making a transfer hologram 123.

This invention may be implemented in such a way that waveguided illumination is used to reduce the length of the display casing.

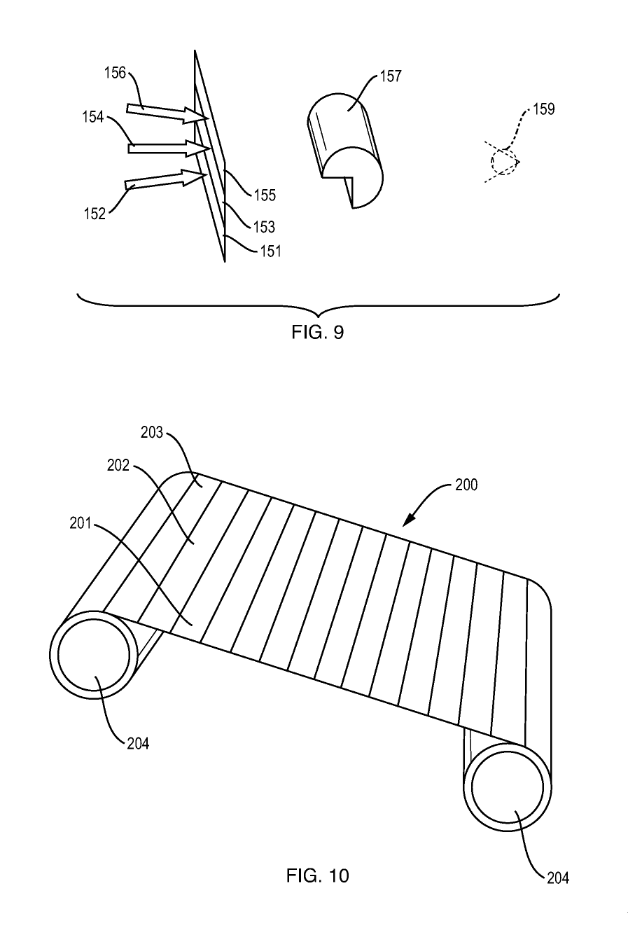

This invention may be implemented in such a way that multiple HPO stripe holograms on the H2 plate are illuminated simultaneously to give multiple vertical views of the same object to provide some vertical parallax. FIG. 9 shows an example of this. Stripes 151, 153 and 155 on an H2 plate 106 are HPO stripe holograms. Each records a different vertical perspective of an object. These stripes are simultaneously illuminated by illumination beams 152, 154 and 156, respectively, to create ureal image 157 with some vertical parallax. Thus, if a viewer 159 changes his or her vertical height, the vertical perspective of the image changes.

In an illustrative embodiment of this invention, H2 is an embossed pattern on foil that runs on rolls. Advantageously, this allows the duration of animation to be increased. FIG. 10 shows an example of H2 foil 200 with HPO stripe holograms 201, 202, 203 embossed on it. The foil 200 runs on rolls 204.

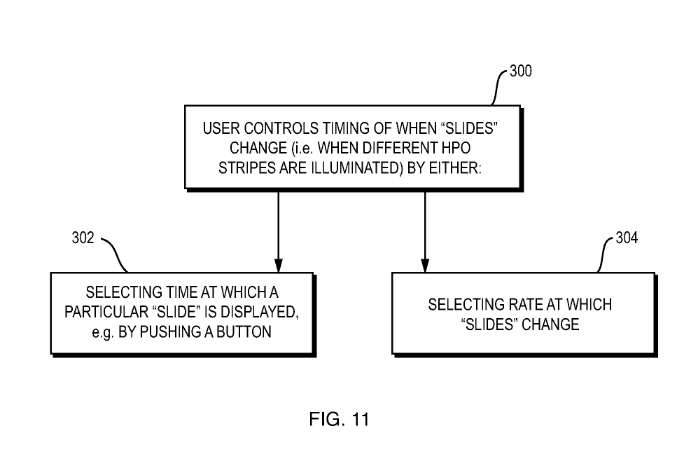

In some implementations, this invention may be used for a holographic slide show. For example, as shown in FIG. 11, a user may control the timing of when “slides” change (i.e., when different HPO stripes are illuminated) 300 in a holographic slide show 300. For example, a user may push a button or otherwise select the time at which to display a particular “slide” 302, or may instead select the rate at which the “slides” change 304.

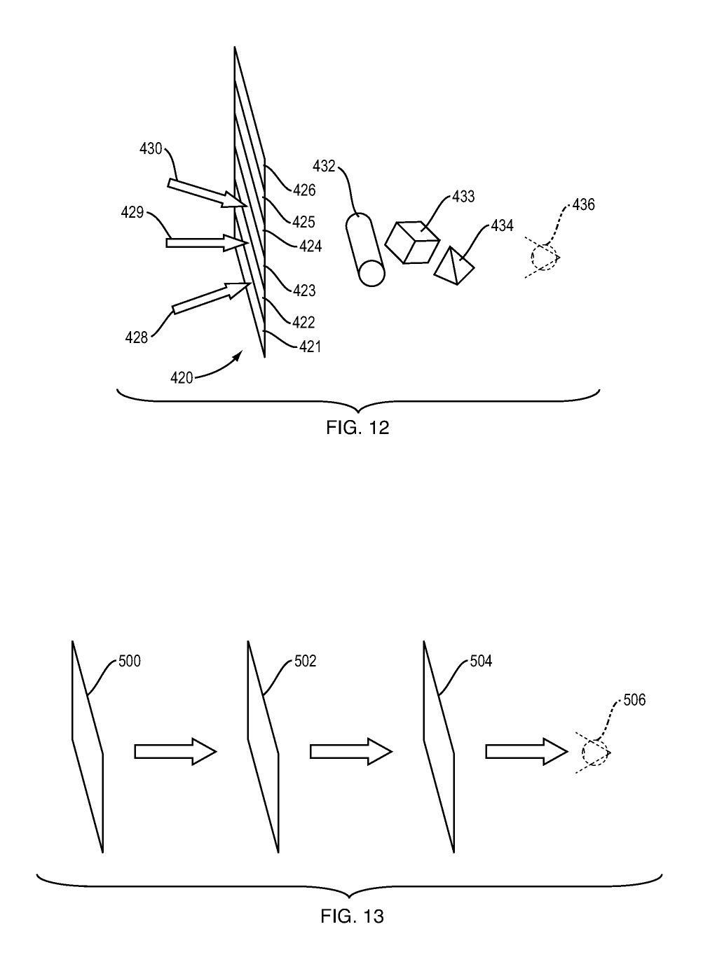

This invention may be implemented so as to permit the simultaneous display of multiple, independent, animated holographic objects. FIG. 12 shows an example of this. Stripes 421, 422 and 423 on an H2 plate 420 are HPO stripe holograms. Each records a different object. These stripes are simultaneously illuminated by illumination beams 428, 429 and 430, respectively, to create three different real images 433, 432 and 434, respectively. Each of these images is of a different object. In order to animate these images, HPO stripe holograms on the H2 may be sequentially illuminated. For example, HPO stripes 424, 425 and 426 may be illuminated next. The different objects may be recorded in different colors. For example, the viewer may see three objects: one red, one green and one blue. The fact that the objects are displayed independently is be useful, for example, in a game in which the action of each object changes as a result of user input.

This invention may be implemented with an LCD shutter or ferroelectic shutter for creating real-time occlusion and other effects. As shown in FIG. 13, light from an H2 hologram 500 may pass through a shutter 502 and a vertical diffuser 504 before reaching a viewer 506.

For clarity's sake, a few more definitions:

As used herein, the terms “horizontal” and “vertical” are construed construed broadly. They apply to any x y coordinate system where the so-called “horizontal” axis is perpendicular to the so-called “vertical” axis. For example, it may be convenient to take devices that are ordinarily upright, and lay them on their side on a table when creating H1 and H2 holograms. Also, note that the orientation of these so-called “horizontal” and “vertical” axes may change from one device to another, for example, if a mirror changes the direction of light traveling between two devices.

As used herein, the term “sequentially” (and its grammatical variations, such as “sequential”): (a) refers to any sequence, (b) is not limited to one at a time, but may refer to more than one at a time, and (c) does not necessarily mean in order, but may refer to a sequence that skips around, out of order.

This invention may be implemented in a variety of ways. Here are some examples:

This invention may be implemented as a method of displaying an animated image, which method comprises the sequential illumination of a plurality of HPO holograms, wherein: (a) said HPO holograms are recorded in or on an H2 medium, (b) said HPO holograms are vertically displaced from each other, and (c) at least partial compensation is made for vertical parallax rotation of said animated image. Furthermore:

(1) said compensation may be achieved, at least in part, by pre-rotating the content of at least one H1 hologram; (2) said compensation may be achieved, at least in part, by translating an H1 master hologram, said H2 medium, or both, between exposures of different said HPO holograms; (3) said compensation may be achieved, at least in part, by illuminating a horizontal strip of an H1 master hologram during holographic transfer to said H2 medium, in such a way that an image created by said illumination of said H1 master hologram has substantially no vertical parallax; (4) a vertical diffuser may be used to diffuse light that has been transmitted through an H1 before said light reaches said H2 medium; (5) a vertical diffuser may be used to diffuse light that has been transmitted through said H2 medium before said light is viewed by a viewer; (6) more than one said HPO hologram may be illuminated at the same time; (7) a plurality of said HPO holograms, at least two of which have different vertical perspectives of the same object, may be illuminated at the same time; and (8) a plurality of said HPO holograms, at least two of which record at least partially non-overlapping images, may be illuminated at the same time.

This invention may be implemented as a system for displaying an animated image, which system comprises: (a) at least one H2 medium for recording, or on which are recorded, a plurality of HPO holograms vertically displaced from each other, and (b) one or more sources of monochromatic light for sequentially illuminating said HPO holograms to display said animated image, wherein said system is adapted to compensate, at least in part, for vertical rotation. Furthermore: (1) said system may further comprise at least one actuator for translating said H2 medium or for translating at least one said light source, in each case during said sequential illumination; (2) a plurality of said sources of monochromatic light may be adapted for being turned on and off at different times to provide said sequential illumination; (3) said system may further comprise a vertical diffuser for diffusing light that exits at least one said HPO hologram before it reaches a viewer; (4) at least some of said HPO holograms may be embossed; (5) at least some of said light sources may be adapted to illuminate more than one said HPO hologram at a time; (6) said system may further comprise a light source and a slit for illuminating a horizontal strip of an H1 master hologram during hologram transfer to said H2 medium, in such a way that an image transmitted by said H1 master hologram has substantially no vertical parallax; (7) said slit may be adapted for being vertically positioned so as to compensate for vertical parallax rotation of said animated image that occurs, or would otherwise occur, because different said HPO holograms have different vertical perspectives during their recording; and (8) said system may further comprise a vertical diffuser for diffusing light that has been transmitted through said H1 master hologram before said light reaches said H2 medium.

This invention may be implemented as a method comprising the following steps, in combination: (a) recording a plurality of HPO holograms on an H2 medium by a recording process that comprises, for each said HPO hologram, the steps of: (I) transmitting light through a horizontal stripe of an H1 in such a way that the image formed by said transmitted light has substantially no vertical parallax, (II) diffusing said transmitted light with a vertical diffuser, before it reaches said H2 medium, (III) using a slit aperture to expose a horizontal strip of said H2 medium to said transmitted light and to a reference beam, and (IV) recording on said H2 medium an interference pattern formed by said transmitted light and said reference beam, and (b) sequentially illuminating at least two said HPO holograms. Furthermore, said method may further comprise the step of vertically diffusing the light from said HPO holograms before it reaches a viewer.

### CONCLUSION

It is to be understood that the methods and apparatus which have been described above are merely illustrative applications of the principles of the invention. Numerous modifications may be made by those skilled in the art without departing from the scope of the invention. The scope of the invention is not to be limited except by the claims that follow.

What is claimed is:

1. A method of displaying an animated image, which method comprises the sequential illumination of a plurality of HPO holograms, wherein:
said HPO holograms are recorded in or on an H2 medium,
said HPO holograms are vertically displaced from each other, and
at least partial compensation is made for vertical parallax rotation of said animated image.

2. The method of claim 1, wherein said compensation is achieved, at least in part, by pre-rotating the content of at least one H1 hologram.

3. The method of claim 1, wherein said compensation is achieved, at least in part, by translating an H1 master hologram, said H2 medium, or both, between exposures of different said HPO holograms.

4. The method of claim 1, wherein said compensation is achieved, at least in part, by illuminating a horizontal strip of an H1 master hologram during holographic transfer to said H2 medium, in such a way that an image created by said illumination of said H1 master hologram has substantially no vertical parallax.

5. The method of claim 5, wherein a vertical diffuser is used to diffuse light that has been transmitted through an H1 before said light reaches said H2 medium.

6. The method of claim 1, wherein a vertical diffuser is used to diffuse light that has been transmitted through said H2 medium before said light is viewed by a viewer.

7. The method of claim 1, wherein more than one said HPO hologram is illuminated at the same time.

8. The method of claim 7, wherein a plurality of said HPO holograms, at least two of which have different vertical perspectives of the same object, are illuminated at the same time.

9. The method of claim 7, wherein a plurality of said HPO holograms, at least two of which at least partially non-overlapping images, are illuminated at the same time.

10. A system for displaying an animated image, which system comprises:
at least one H2 medium for recording, or on which are recorded, a plurality of HPO holograms vertically displaced from each other, and
one or more sources of monochromatic light for sequentially illuminating said HPO holograms to display said animated image,
wherein said system is adapted to compensate, at least in part, for vertical parallax rotation.

11. The system of claim 10, further comprising at least one actuator for translating said H2 medium or for translating at least one said light source, in each case during said sequential illumination.

12. The system of claim 10, wherein a plurality of said sources of monochromatic light are adapted for being turned on and off at different times to provide said sequential illumination.

13. The system of claim 10, further comprising a vertical diffuser for diffusing light that exits at least one said HPO hologram before it reaches a viewer.

14. The system of claim 10, wherein at least some of said HPO holograms are embossed.

15. The system of claim 10, wherein at least some of said light sources are adapted to illuminate more than one said HPO hologram at a time.

16. The system of claim 10, further comprising a light source and a slit for illuminating a horizontal strip of an H1 master hologram during hologram transfer to said H2 medium, in such a way that an image transmitted by said H1 master hologram has substantially no vertical parallax.

17. The system of claim 16, wherein said slit is adapted for being vertically positioned so as to compensate for vertical parallax rotation of said animated image that occurs, or would otherwise occur, because different said HPO holograms have different vertical perspectives during their recording.

18. The system of claim 16, further comprising a vertical diffuser for diffusing light that has been transmitted through said H1 master hologram before said light reaches said H2 medium.

19. A method comprising the following steps, in combination:
recording a plurality of HPO holograms on an H2 medium by a process that comprises, for each said HPO hologram, the steps of:
transmitting light through a horizontal stripe of an H1 in such a way that the image formed by said transmitted light has substantially no vertical parallax,
diffusing said transmitted light with a vertical diffuser before it reaches said H2 medium,
exposing a horizontal strip of said H2 medium to said transmitted light and to a reference beam, and
record on said H2 medium an interference pattern formed by said transmitted light and said reference beam, and
sequentially illuminating at least two said HPO holograms.

20. The method of claim 19, further comprising the step of vertically diffusing the light from said HPO holograms before it reaches a viewer.
